(19) United States
(12) Patent Application Publication
(10) Pub. No.: US 2026/0160555 A1
(43) Pub. Date: Jun. 11, 2026

(54) LORENTZ FORCE VELOCIMETER

(71) Applicant: Honeywell International Inc., Charlotte, NC (US)

(72) Inventors: Andrew Roberts Brown, Golden Valley, MN (US); Ved Gund, Minneapolis, MN (US); John Reinke, Plymouth, MN (US); Markus Hans Gnerlich, Plymouth, MN (US)

(73) Assignee: Honeywell International Inc., Charlotte, NC (US)

(21) Appl. No.: 19/181,728

(22) Filed: Apr. 17, 2025

Related U.S. Application Data
(60) Provisional application No. 63/635,741, filed on Apr. 18, 2024.

(51) Int. Cl. G01C 21/16; G01C 21/08; G01P 1/02; G01P 3/50; G01S 19/31

(52) U.S. Cl. CPC G01C 21/188; G01C 21/08; G01P 1/026; G01P 3/50; G01S 19/31

(57) ABSTRACT

One or more Lorentz force velocimeters are provided. Each Lorentz force velocimeter is configured to sense electric field strength. Each Lorentz force velocimeter measures electric field strength due to a magnetic Lorentz force. Lorentz electric field is derived from alternating measurements of the ambient electric field and a sum of the ambient electric field and the Lorentz electric field. To accomplish this, optionally, a magnetic shield shutter alternatively (a) encloses, at least partially, the electric field sensor and diminishes the Earth's magnetic field strength at the electric field sensor and (b) does not enclose the electric field sensor and does not diminish the Earth's magnetic field strength at the electric field sensor.

### CROSS-REFERENCE TO RELATED APPLICATIONS

The present application claims benefit of U.S. Patent Application Ser. No. 63/635,741 filed Apr. 18, 2024; the entire contents of the aforementioned patent application are incorporated herein by reference as if set forth in its entirety.

### BACKGROUND

Global navigation satellite systems (GNSSs) are used to facilitate navigation of vehicles due to their accuracy. GNSS signals used for such navigation can be unreliable due to jamming and/or spoofing.

Inertial navigation using accelerometers and gyroscopes can be used in lieu of GNSS navigation. Because measured accelerations and rotation rates must be integrated to ascertain position and attitude, small bias errors in each accelerometer measurement and each gyroscope measurement can result in increasingly large errors in position in attitude with respect to time. Such errors generally grow proportionally to the square of time.

To reduce such errors, inertial navigation data and data from one or more other types of measurements can be combined, e.g., using a state estimator. For example, data may be obtained from a star tracker or a barometric pressure sensor; however, these techniques have various drawbacks and limitations. For example, a star tracker may not operate properly because objects in the atmosphere or space may be obscured, e.g., by cloud cover.

A velocimeter have been proposed as a navigational aiding device in Chinese Patent No. 112179347A entitled “Combined Navigation Method Based on Spectrum Red Shift Error Observation Equation” and granted on Oct. 18, 2022. However, the velocimeter relies on star tracking and may not operate properly because stars are obscured.

### SUMMARY

In some aspects, the techniques described herein relate to an apparatus for generating a signal representative of a Lorentz electrical field strength at a body, the apparatus including: at least one Lorentz force velocimeter, each of which includes: an electric field sensor; a circuit coupled to the electric field sensor; a magnetic shield shutter configured to alternatively enclose the electric field sensor and not enclose, at least partially, the electric field sensor; and wherein the electric field sensor is configured to generate a first signal representing alternatively a strength of a combination of an ambient electric field and a Lorentz electric field and a strength of the ambient electric field; wherein the circuit is configured to, using the first signal, generate a second signal representing a strength of the Lorentz electric field by suppressing the strength of the ambient electric field from the strength of the combination of the ambient electric field and the Lorentz electric field.

In some aspects, the techniques described herein relate to a method for generating a signal representative of Lorentz electrical field strength at a body, the method including: for each Lorentz force velocimeter, enclosing an electric field sensor with a magnetic shield shutter; for each Lorentz force velocimeter, not enclosing, at least partially, the electric field sensor with the magnetic shield shutter; for each Lorentz force velocimeter, generating a first signal representing alternatively a strength of a combination of a Lorentz electric field and an ambient electric field and a strength of the ambient electric field; and for each Lorentz force velocimeter, using the first signal, generating a second signal representing a strength of the Lorentz electric field sensed using a Lorent force velocimeter.

In some aspects, the techniques described herein relate to an apparatus for generating a signal representative of a Lorentz electrical field strength at a body, the apparatus including: the body; and at least one Lorentz force velocimeter, each of which is on and/or in the body and includes: an electric field sensor; a circuit coupled to the electric field sensor; a magnetic shield shutter configured to alternatively enclose the electric field sensor and not enclose, at least partially, the electric field sensor; and wherein the electric field sensor is configured to generate a first signal representing alternatively a strength of a combination of an ambient electric field and a Lorentz electric field and a strength of the ambient electric field; wherein the circuit is configured to, using the first signal, generate a second signal representing a strength of the Lorentz electric field by suppressing the strength of the ambient electric field from the strength of the combination of the ambient electric field and the Lorentz electric field.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A illustrates a diagram of one embodiment of a body on or in a navigation system is mounted and according to embodiments of the invention.

FIG. 1B illustrates a diagram of one embodiment of the navigation system.

FIG. 1C illustrates a block diagram of one embodiment of the one or more Lorentz force velocimeters.

FIG. 2A illustrates one embodiment of a Lorentz force velocimeter which is configured to measure the Lorentz electric field strength along a unique axis of the orthogonal coordinate system and to suppress, with a magnetic shield shutter, the Earth's magnetic field at or about an electric field sensor.

FIG. 2B illustrates another embodiment of a Lorentz force velocimeter which is configured to not suppress, with a magnetic shield shutter, the Earth's magnetic field (and thus not suppress the Lorentz electric field at or about an electric field sensor.

FIG. 3 illustrates a diagram of one embodiment of a resonant electric field sensor configured to be used with embodiments of the invention.

FIG. 4 illustrates a flow diagram of an exemplary method for determining a Lorentz electric field strength on a body using at least one Lorentz force velocimeter on and/or in the body.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that structural, mechanical, and/or electrical changes may be made. Furthermore, each method presented in the drawing figures and the specification is not to be construed as limiting the order in which the individual steps may be performed. The following detailed description is not to be taken in a limiting sense.

Embodiments of the invention provide one or more Lorentz force velocimeters each of which is configured to sense electric field strength orthogonal to a unique axis of a coordinate system, e.g., an orthogonal coordinate system. Using each electric field strength, a vector velocity of a body (to which the one or more Lorentz force velocimeter are attached on and/or are in) may be derived. Each Lorentz force velocimeter measures electric field strength due to a magnetic Lorentz force, without relying on acceleration measurements which must be integrated over time. The Lorentz force velocimeter utilizes the magnetic Lorentz equation:

$${F}_{L} = q * v \times B ,$$

where F_{L} is a Lorenz force, q is charge, and v×B is the Lorentz electric field and is a cross product of vector velocity (v) and vector magnetic field (B); an external electric field of the Lorentz equation is assumed to be zero and is omitted from the magnetic Lorentz equation. Typically, the magnetic field is of the Earth which is known at different geographical positions on and above the Earth and/or may be measured by a magnetometer. The charge is controlled and known by the Lorentz force velocimeter. The Lorentz force velocimeter measures the Lorentz electric field. Using the Lorentz electric field, velocity can be derived using the magnetic Lorentz equation. Although the derived velocity will still have a bias error, the position error due to the velocity measurement grows proportional to time, instead of time squared as occurs when the velocity is derived from an acceleration measurement.

The body may be any type of device, e.g., a vehicle, a projectile, a human being, or an animal. Optionally, the vehicle may be a spaceborne, an airborne, a waterborne (including a submersible), or a terrestrial borne vehicle.

Embodiments of the velocimeter include an electric field sensor. The electric field sensor is exposed to a Lorentz electric field and an ambient electric field. Motion of the electric field sensor through the Earth's magnetic field generates the Lorentz electric field equal to the velocity of the electric field sensor, along a unique axis of the coordinate system, multiplied by the Earth's magnetic field.

The ambient electric field is due to an atmospheric electric field and/or electric field(s) generated by other device(s), e.g., electronic device(s). Because the Earth's magnetic field is only about 25 to 65 microTesla, the Lorentz electric field measured by the electric field sensor due to the Earth's magnetic field is extremely small and susceptible to being hidden by a much larger ambient electric field.

Optionally the Lorentz electric field is derived from a measurement of the ambient electric field and a measurement a sum of the ambient electric field and the Lorentz electric field. To accomplish this, in embodiments of the invention, a magnetic shield shutter alternatively, e.g., periodically, (a) encloses, at least partially, the electric field sensor and diminishes the Earth's magnetic field strength at the electric field sensor and (b) does not enclose the electric field sensor and does not diminish the Earth's magnetic field strength at the electric field sensor. When enclosed, at least partially, the electric field sensor only measures the ambient electric field. When not enclosed, the electric field sensor measures an electric field strength of a combination of the ambient electric field and the electric field due to the Earth magnetic field. If the electric field sensor is a resonant electric field sensor, then the frequency at which the magnetic shield shutter alternates between enclosing and not enclosing (at least partially) the electric field sensor is a resonant frequency of the resonant electric field sensor.

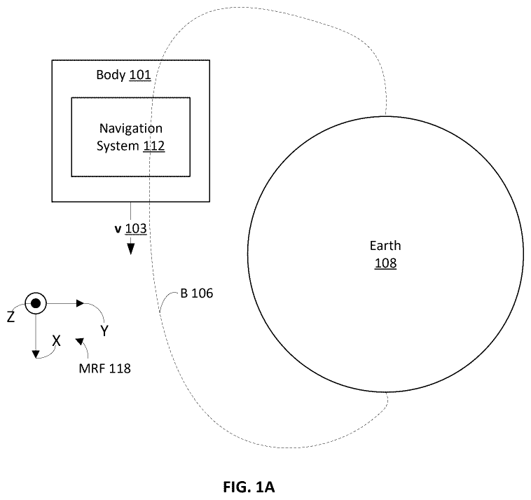

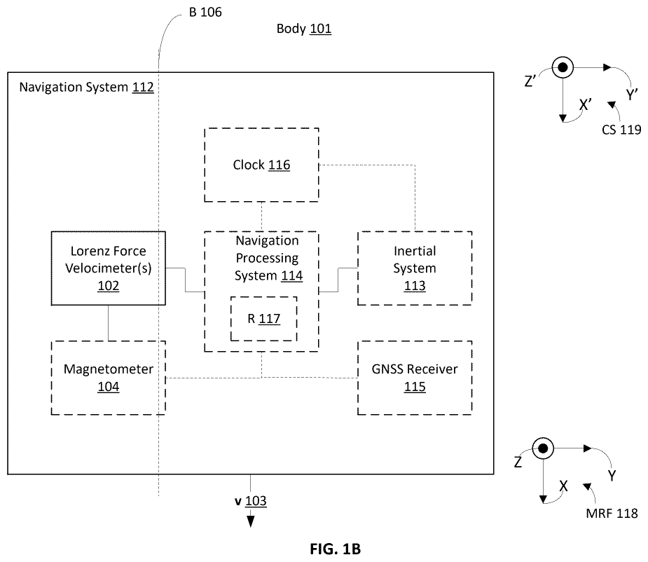

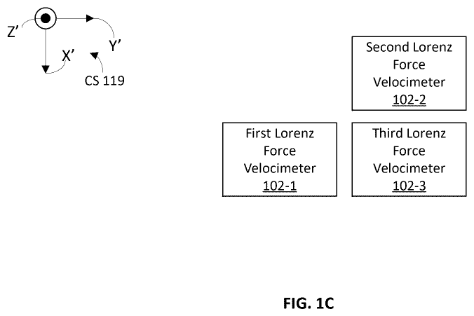

FIG. 1A illustrates a diagram of one embodiment of a body 101 on or in a navigation system 112 is mounted and according to embodiments of the invention. A magnetic field 106 of the Earth 108 flows through the navigation system 112, and components thereof, as is described elsewhere herein. The body 101 moves with a vector velocity v 103 with respect to a moving reference frame (MRF) 118, e.g., along the x axis X of the moving reference frame 118. For pedagogical purposes, the moving reference frame 118 is illustrated with an x axis X, a y axis Y, and a z axis Z. The Earth's magnetic field (B) 106 intersects each of the body 101 and the navigation system 112.

FIG. 1B illustrates a diagram of one embodiment of the navigation system 112. The illustrated navigation system 112 includes one or more Lorentz force velocimeters 102. Optionally, the navigation system 112 optionally includes an inertial system (or inertial circuitry) 113. Optionally, each of the one or more Lorentz force velocimeters 102 and the optional inertial system 113 are communicatively coupled to an optional navigation processing system (or navigation processing circuitry) 114. The Earth's magnetic field 106 flows through the one or more Lorentz force velocimeters 102.

Each Lorentz force velocimeter, of the one or more Lorentz force velocimeters 102, is configured to measure the Lorentz electric field along a unique axis of a coordinate system 119 or to generate a signal representative of an electrical field along a unique axis of the coordinate system 119 at the Lorent force velocimeter. Optionally, the coordinate system (CS) 119 is an orthogonal coordinate system (illustrated in FIG. 1B for pedagogical purposes) in which each axis is orthogonal to each of the other axes. For pedagogical purposes, the coordinate system 119 is illustrated with an x axis X′, a y axis Y′, and a z axis Z′.

FIG. 1C illustrates a block diagram of one embodiment of the one or more Lorentz force velocimeters 102. The one or more Lorentz force velocimeters 102 illustrated in FIG. 1C includes three Lorentz force velocimeters 102-1, 102-2, 102-3. Optionally, the different axes are orthogonal to one another. Optionally, each such axis is an axis of the moving reference frame 118.

Returning to FIG. 1B, optionally, each of the one or more Lorentz force velocimeters 102 is configured to either:
(a) determine the Lorentz electric field strength along a unique axis of the coordinate system 119 and, using the Lorentz electric field strength and knowledge of local magnetic field, calculate a velocity of the body 101, e.g., or the navigation system 112 or the one or more Lorentz force velocimeters 102 there on and/or in;
(b) determine the Lorentz electric field strength along the unique axis of the coordinate system 119. Using the Lorentz electric field strength and the knowledge of the local magnetic field, the optional navigation processing system 114 is configured to determine the velocity of the body 101.
(c) determine the Lorentz electric field strength along the unique axis of the coordinate system 119 by suppressing a strength of an ambient electric field from a strength of a combination of the ambient electric field and the Lorentz electric field. Each field strength is along a unique axis of the coordinate system 119. The optional navigation processing system 114 is configured to perform such suppression, and, using the Lorentz electric field strength and the knowledge of the local magnetic field, to determine the velocity of the body 101.

Optionally, the optional inertial system 113 includes an inertial navigation system or an inertial measurement unit. An inertial measurement unit includes at least one accelerometer and/or at least one gyroscope. An inertial navigation system includes an inertial measurement unit and is configured to use inertial data measured therefrom to determine attitude, with respect to the moving reference frame 118, and position. If the optional inertial system 113 is an inertial measurement unit, then the optional navigation processing system 114 is configured to use inertial data measured by the inertial measurement unit to determine position and attitude.

Optionally, the navigation system 112 further includes a magnetometer 104 mounted on or in the body 101. The Earth's magnetic field 106 flows through the optional magnetometer 104. The optional magnetometer 104 is configured to measure the Earth's magnetic field 106 is communicatively coupled, e.g., directly or through the optional navigation processing system 114, to the velocimeter 102. A magnetic field B 106 of the Earth 108 flows through the velocimeter 102 and optionally through the optional magnetometer 104. Magnetic field strength at a position of the body may be measured by the magnetometer 104, an optional relationship 117 described elsewhere herein, or any other means of measuring magnetic field strength of the body at a position.

Optionally, the optional navigation processing system 114 is further configured to determine the Earth's magnetic field value at the geographical position of the body 101 using the geographical position of the body 101 and ascertaining a predetermined Earth's magnetic field, e.g., from a magnetic field map, at a geographic position of the body 101. The geographic position of the body 101 may be obtained from the optional navigation processing system 114, the optional inertial system 113, and/or and an optional GNSS receiver 115. The predetermined Earth's magnetic field is obtained from an optional predetermined relationship, or relationship, (R) 117 between geographic position and Earth's magnetic field. Such optional relationship 117 may be optionally stored in the optional navigation processing system 114 or elsewhere; for pedagogical purposes, FIG. 1B illustrates the optional relationship 117 as being stored in the optional navigation processing system 114. Optionally, the relationship 117 may be in the form of a map, database, equation(s), or any other form. The magnetometer 104 and the optional relationship 117 may be used in the alternative or in combination with one another.

Optionally, the navigation system 112 includes a Global Navigation Satellite System (GNSS) receiver 115 for one or more GNSSs, e.g., Global Positioning System (GPS), Galileo, Beidou, and/or GLObalnaya NAvigatsionnaya Sputnikovaya Sistema (GLONASS). The optional GNSS receiver 115 is configured to generate geographic data from which the geographic position of the body 101 can be derived, and time and date data. The optional GNSS receiver 115 is configured to be communicatively coupled to the optional navigation processing system 114 and/or the magnetometer 104. One or both of the optional navigation processing system 114 and the magnetometer 104 are further configured to use the geographic data to derive the geographic position of the body 101.

Optionally, the navigation system 112 includes an optional clock 116, e.g., an atomic clock, configured to provide time data. The optional clock 116 is configured to be communicatively coupled to the optional navigation processing system 114 and/or the optional inertial system 113. Each of the optional navigation processing system 114 and/or the optional inertial system 113 may be further configured to use the time data to determine the geographic position of the body 101.

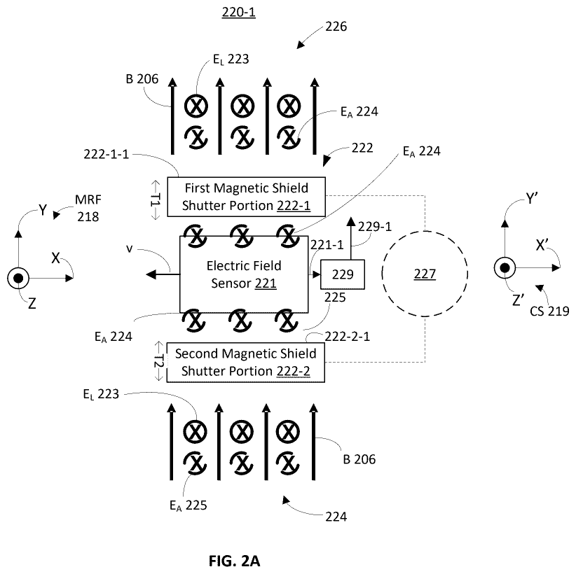

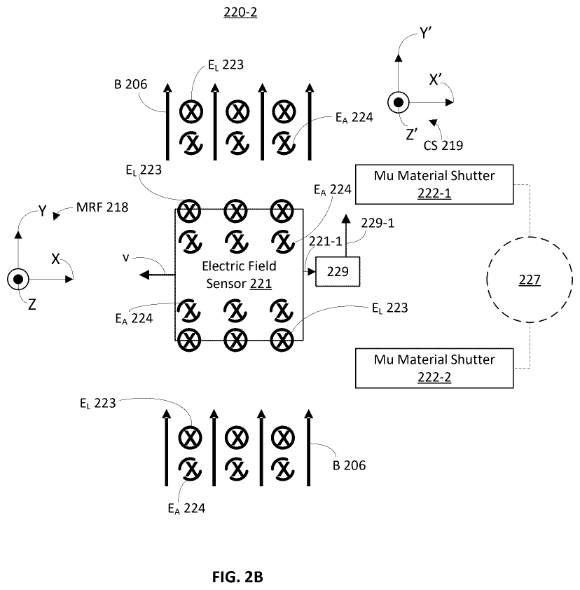

Each of the one or more Lorentz force velocimeters 102 includes an electric field sensor and a magnetic shield shutter. The magnetic shield shutter is alternatively (a) placed between the electric field sensor and the Earth's magnetic field 106 so that the magnetic shield shutter shields, at least partially, the electric field sensor from the Earth's magnetic field 106 and (b) not placed between electric field sensor and the Earth's magnetic field 106 so that the magnetic shield shutter does not shield the electric field sensor from the Earth's magnetic field 106. For pedagogical purposes, this is illustrated in FIG. 2A as being performed by electromechanical displacement of the magnetic shield shutter over and away from the electric field sensor. However, in other embodiments, the magnetic shield shutter may be electrically or optically controlled by using material whose magnetic permeability is respectively electrically or optically controlled.

FIG. 2A illustrates one embodiment of a Lorentz force velocimeter 220-1 which is configured to measure the Lorentz electric field strength along a unique axis of the orthogonal coordinate system 219 and to suppress, with a magnetic shield shutter 222, the Earth's magnetic field 206 at or about an electric field sensor 221. For pedagogical purposes, the Lorentz force velocimeter 220-1 illustrated in FIG. 2A measures velocity v along an x axis X′ of the coordinate system 219. The Lorentz force velocimeter 202, e.g., the electric field sensor 221 thereof and the moving reference frame 218 thereof, moves through the Earth's magnetic field 206 at a scalar velocity v along an axis, e.g., the x axis X′, of the coordinate system 219.

The illustrated Lorentz force velocimeter 202 includes the magnetic shield shutter 222 and an electric field sensor 221. The magnetic shield shutter 222 includes at least two magnetic shield portions, e.g., a first magnetic shield shutter portion 222-1 and a second magnetic shield shutter portion 222-2. Each portion 222-1, 222-2 has a surface 222-1-1, 222-2-1. For pedagogical purposes, each surface 222-1-1, 222-2-1 is illustrated as being orthogonal to the Earth's magnetic field 206; however, the Earth's magnetic field 206 may not be orthogonal to such surfaces 222-1-1, 222-2-1. Optionally, the Lorentz force velocimeter 202 includes an electrical actuator 227, e.g., an electric motor configured to move the magnetic shield shutter 222, e.g., the first and the second portions thereof; however, alternatively, the magnetic shield shutter 222 may be moved in other ways.

If the magnetic shield shutter 222 where to act as Faraday cage, external electric fields create an electric field within the Faraday cage which cancels the Lorentz electric field. The magnetic shield shutter 222, e.g., the portion 222-1, 222-2 thereof, includes mu material. The mu material is configured to suppress, e.g., diminish to zero, the strength of magnetic field lines through the mu material; thus, the mu material has a high magnetic permeability. Generation of the electric field which cancels the Lorentz electric field can be achieved in different ways.

To avoid generating an electric field which cancels the Lorentz force electric field, the mu material must also be configured to suppress, e.g., diminish to zero, electric field strength in the mu material (at least in a direction parallel to Lorentz electric field lines in the Lorentz force velocimeter 220-1, e.g., in and/or about the electric field sensor 221). Optionally, a mu material that can do the foregoing and has high magnetic permeability is a ferrite, e.g., a permalloy-coated ferrite. Optionally, a mu material configured to suppress, e.g., diminish to zero, an electric field strength in the mu material (in the direction parallel to Lorentz electric field lines in the Lorentz force velocimeter 220-1, e.g., in and/or about the electric field sensor 221) is an electrically conductive, highly magnetic permeable material, such as mu metal, that is sufficiently thin and thus suppresses, e.g., diminishes to zero, the electric field strength in the mu material. Optionally, such dimension is a thickness T1, T2 of each portion 222-1 222-1 of the magnetic shield shutter 222. Because the electrically conductive, highly magnetic permeable material is relatively thin, the magnetic shield shutter 222, e.g., each portion 222-1, 222-2 thereof, has a low electrical conductivity in the direction parallel to Lorentz electric field lines in the Lorentz force velocimeter 220-1, e.g., in and/or about the electric field sensor 221.

The mu material has high magnetic permeability and thus suppresses, e.g., diminishes to zero, a strength of a magnetic field from flowing through the magnetic shield shutter 222, e.g., the portions 222-1, 222-2. In FIG. 2A, the magnetic shield shutter 222, e.g., the portions 222-1, 222-2, encloses, at least partially, the electric field sensor 221, and thus suppresses (e.g., reduces to zero), for example, a strength of a magnetic field (for example, the Earth's magnetic field 206) in the interior volume 225 of the magnetic shield shutter 222, e.g., in and/or about the electric field sensor 221. As a result, a strength of the Lorentz force electric field 223 in an interior volume 225, e.g., in and/or about the electric field sensor 221) is suppressed, e.g., reduced to zero.

The magnetic shield shutter 222, e.g., each portion 222-1, 222-2 thereof, has at least one surface intersecting lines of the Earth's magnetic field 206 which, without the magnetic shield shutter 222, would intersect the electric field sensor 221. The magnetic shield shutter 222-1, 222-2 includes at least one portion 222-1, 222-2 each of which has a surface 222-1-1, 222-2-1 intersecting lines of the Earth's magnetic field 206 which would intersect the electric field sensor 221. For pedagogical purposes, the illustrated magnetic shield shutter 222-1, 222-2 includes a first portion 222-1 and a second portion 222-2. The lines of the Earth's magnetic field 206 extend from and into an exterior region 226 exterior to the Lorentz force velocimeter 202, e.g., the magnetic shield shutter 222 and the electric field sensor 221 thereof.

Due to magnetic shielding from the magnetic shield shutter 222, the electric field sensor 221 is only exposed to the ambient electric field (E_{A}) 224. Any Lorentz electric field (E_{L}) 223 is in the exterior region and not sensed by the electric field sensor 221 due to the magnetic shielding provided by the magnetic shield shutter 222. Thus, when the magnetic shield shutter 222 encloses the electric field sensor 221, the electric field sensor 221 generates a signal 221-1 whose amplitude is representative of a strength of the ambient electric field 224. However, the magnetic shield shutter 222 alternatively, e.g., periodically, encloses and not enclose, at least partially, the electric field sensor 221.

FIG. 2B illustrates another embodiment of a Lorentz force velocimeter 220-2 which is configured to not suppress, with a magnetic shield shutter 222, the Earth's magnetic field 206 (and thus not suppress the Lorentz electric field E_{L}) at or about an electric field sensor 221. In FIG. 2B, the magnetic shield shutter 222 no longer encloses, at least partially, (and thus no longer diminishes the Earth's magnetic field strength at) the electric field sensor 221. When the magnetic shield shutter 222-1, 222-2 no longer encloses, at least partially, the electric field sensor 221, the electric field sensor 221 is exposed to not only the ambient electric field 224, but also to the Lorentz electric field 223 created by the Earth's magnetic field 206. Thus, when the magnetic shield shutter 222 does not enclose, at least partially, the electric field sensor 221, the electric field sensor 221 generates a signal 221-1 whose amplitude is representative of a strength of a sum of the ambient electric field 224 and the Lorentz electric field 223.

The Lorentz force velocimeter 220-1, 220-2 also includes a circuit (or an electrical circuit or a demodulator or demodulator circuitry) 229 communicatively coupled to the electric field sensor 221. Optionally, the circuit 229 is a chopper demodulator. The Lorentz force velocimeter 220-1, 220-2 is configured to provide to the circuit 229 a signal 221-1 whose amplitude is representative of alternatively, e.g., periodically, (a) a strength of the ambient electric field 224 and (b) a strength of a combination of the ambient electric field 224 and the Lorentz electric field 223 and. The circuit 229 is configured to extract a strength 229-1 of the Lorentz electric field 223 from the received signal 221-1.

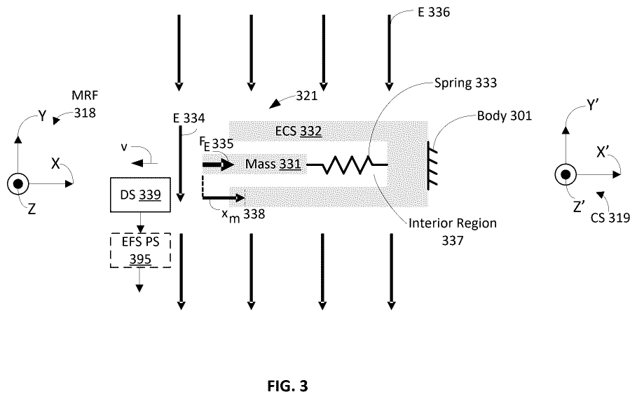

FIG. 3 illustrates a diagram of one embodiment of a resonant electric field sensor 321 configured to be used with embodiments of the invention. However, other types and/or implementations of electric field sensors may be utilized.

The illustrated electric field sensor 321 includes a mass 331 coupled to an electrical conductor shield (ECS) 332 by a spring 333. The electrical conductor shield 332 is attached to the body 301. The electric field sensor 321 has an interior region (or interior volume) 337. The electric field sensor 321 also includes a displacement sensor (DS) 339 configured measure a value of a displacement distance (xₘ) 338.

An electric field (E) 336 is illustrated, for pedagogical purposes, flowing parallel to y axis Y′ of the coordinate system 319. The electric field 336 may be, for example, the ambient electric field or a combination of the ambient electric field and the Lorentz electric field. The electric conductor shield 332 suppresses, e.g., diminishes to zero, a strength of the electric field 336 in the interior region 337.

The spring 333 causes the mass 331 to protrude, at least partially, outside of the interior region 337. Thus, at least a portion of the mass 331 is exposed to the electric field 336. Because the portion of the mass 331, exposed to the electric field 336 includes an electrical conductor, the electric field creates an electrostatic force (FE) 335 on the mass 331, e.g., perpendicular to the electric field 336. The electrostatic force 335 occurs in the direction that minimizes stored energy within the electric field 334 incident on the electric field sensor 321 which causes the conductor to be pulled further outside of the electrical conductor shield 332. As a result, the mass 331 is displaced away from the spring 333 by a displacement distance (xₘ) 338. The value of the displacement distance 338 or a signal representative of the value of the displacement distance 338 is generated by the displacement sensor 339. Optionally, the displacement sensor 339 is a capacitive sensor and/or an optical sensor. A capacitive sensor includes two electrodes and whose voltage varies as a function of the value of the displacement distance 338. Alternatively, a voltage bias is placed across the two electrodes, and a current or voltage is generated as the displacement distance 338 varies and which is proportional to a velocity v of the mass 331. One electrode is attached to or is part of the mass 331. The displacement distance 338 can be calculated by integrating velocity measurements (derived from the generated current or voltage) over time. The optical distance sensor includes a source of light, e.g., a light emitting diode or a laser, and an optical detector; the optical distance sensor is configured to at least determine a round trip time of flight which can be used to ascertain the value of the displacement distance 338.

The following equation is a means of calculating a magnitude of the electric field 334 incident on the electric field sensor 321 when displacement distance 338, spring constant, electric permittivity and cross-sectional area are known:

$$\sqrt{\frac{2 * {x}_{m} * k}{{ε}_{o} * A}} ,$$

wherein xₘ is a value of the displacement distance, k is a spring constant of the spring 333, ε₀ is vacuum permittivity, and A is a cross-sectional area of mass 331 in a plane normal to the electrostatic force 335.

Optionally, the electric field sensor (EFS) 321 includes an EFS processing system (or EFS processing circuit) 395. Optionally, the EFS processing system 395 includes at least one memory circuit communicatively coupled to at least one processor circuit. The EFS processing system 395 is optionally configured to determine the value of the displacement distance 338, electrical field strength (using the value of the displacement distance), and/or the velocity v along the unique axis of the coordinate system 319 (by determining the Lorentz electrical field strength pursuant to techniques described elsewhere herein). Optionally, the EFS processing system 395 is further configured to control position of the magnetic shield shutter, and thus when and at what frequency the magnetic shield shutter shields (at least in part) and does not shield the electronic field sensor 321 from the Earth's magnetic field as further described elsewhere herein. Alternatively, the magnetic shield shutter control can be implemented in other ways.

Optionally, the electric field sensor may be implemented as a resonant electric field sensor. A resonant electric field sensor will amplify electric fields occurring at the resonance frequency of the sensor by quality factor Q, resulting in higher sensitivity. Thus, a resonant electric field sensor can detect smaller electric field strengths.

An electric field sensor, including a resonant electric field sensor, includes a spring mass system. The spring mass system has a resonant frequency equal to:

$$\frac{1}{2 * π} * \sqrt{\frac{k}{m}} ,$$

wherein k is a spring constant of the spring and m is a mass of the mass attached to the spring. In a resonant electric field sensor, a drive signal is applied to an actuator, e.g., a capacitive structure in which one plate is attached to or is part of the mass. The actuator produces a driving force which causes the mass to move. The resonant frequency of the spring mass system is sensed by a sensor (e.g., the displacement sensor) over time. In a Lorentz force velocimeter including a resonant electric field sensor, the magnetic shield shutter periodically shields, at least partially, and does not shield the resonant electric field sensor at the sensed resonant frequency. Sensing of the resonant frequency may be performed using techniques utilized in microelectromechanical system (MEMS) gyroscopes, e.g., electrostatic sensing, piezoelectric sensing, laser doppler vibrometry, and/or frequency modulation sensing. Exemplary MEMS resonant electric field sensors are illustrated in Wang, G., Yang, P., Chu, Z., Ran, L., Li, J., Zhang, B., & Wen, X. (2024). A Review on Resonant MEMS Electric Field Sensors. Micromachines, 15(11), 1333. https://doi.org/10.3390/mi15111333 which is incorporated by reference in its entirety herein.

For example, when electrostatic sensing is used, the displacement sensor 339 is used to extract both a signal representative of a value of a displacement distance (xₘ) 338 and a sense current indicative of the resonant frequency. To discriminate between each signal, the drive signal can be out of phase, e.g., by ninety degrees, from the sensed resonant frequency. Thus, for example, in-phase and quadrature demodulation can be used to extract the signal representative of a value of a displacement distance (xₘ) 338 and a sense current indicative of the resonant frequency.

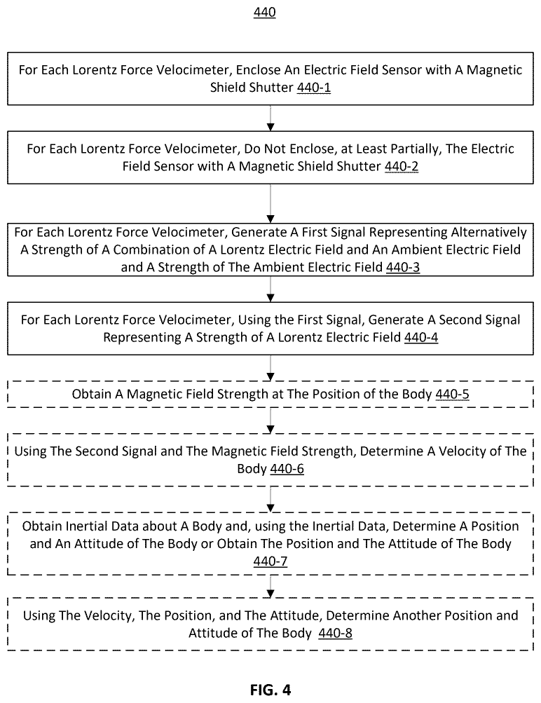

FIG. 4 illustrates a flow diagram of an exemplary method 440 for determining a Lorentz electric field strength on a body using at least one Lorentz force velocimeter on and/or in the body. Exemplary method 440 may be implemented by one or more of the apparatuses illustrated in FIGS. 1A-3. To the extent the methods herein are described herein as being implemented with one or more of the apparatuses illustrated in FIGS. 1A-3, it is to be understood that other embodiments can be implemented in other ways. Techniques described with respect to the embodiments illustrated by FIGS. 1A-3 may be applicable to the method 440.

The blocks of the flow diagrams herein have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 440-1, for each Lorentz force velocimeter, an electric field sensor is enclosed with a magnetic shield shutter. In block 440-2, for each Lorentz force velocimeter, the electric field sensor is not enclosed, at least partially, with the magnetic shield shutter.

In block 440-3, for each Lorentz force velocimeter, a first signal is generated. The first signal represents alternatively, e.g., periodically, a strength of a combination of a Lorentz electric field and an ambient electric field and a strength of the ambient electric field.

In block 440-4, for each Lorentz force velocimeter, using the first signal, a second signal is generated, e.g., using the circuit (for example the demodulator) described elsewhere herein. The second signal represents a strength of the Lorentz electric field sensed using the Lorent force velocimeter.

In optional block 440-5, a magnetic field strength at a position of the body is obtained. Optionally, the magnetic field may be obtained from a magnetometer, from the relationship (described elsewhere herein) using a position of the body, or any other means of measuring magnetic field strength at a position of the body.

In optional block 440-6, using the second signal and the magnetic field strength at the position of the body, a velocity of the body is determined. In optional block 440-7, either (a) inertial data about a body is obtained, and a position of the body and an attitude, with respect to a moving reference frame, of the body are determined, or (b) the position of the body and the attitude, with respect to a moving reference frame, of the body are obtained.

In optional block 440-8, using the velocity of the body, the position of the body, and the attitude, with respect to the moving reference frame, of the body, another, e.g., more accurate than the position and attitude obtained or determined in optional block 440-6, position and attitude of the body are determined. Optionally, such determination may be made with a type of Kalman filter or other type of estimator or the like configured to use aiding data such as the velocity of the body.

Optionally, embodiments of the invention may be implemented using micro-electromechanical system (MEMS) construction techniques. While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

Terms of relative position as used in this application are defined based on a plane parallel to the conventional plane or working surface of a material (e.g., a layer or a substrate), regardless of orientation. Terms such as “on,” “higher,” “lower,” “over,” “top,” and “under” are defined with respect to the conventional plane or working surface being on the top surface of a layer or substrate, regardless of orientation. The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

### Exemplary Embodiments

Clause 1. An apparatus for generating a signal representative of a Lorentz electrical field strength at a body, the apparatus comprising: at least one Lorentz force velocimeter, each of which includes: an electric field sensor; a circuit coupled to the electric field sensor; a magnetic shield shutter configured to alternatively enclose the electric field sensor and not enclose, at least partially, the electric field sensor; and wherein the electric field sensor is configured to generate a first signal representing alternatively a strength of a combination of an ambient electric field and a Lorentz electric field and a strength of the ambient electric field; wherein the circuit is configured to, using the first signal, generate a second signal representing a strength of the Lorentz electric field by suppressing the strength of the ambient electric field from the strength of the combination of the ambient electric field and the Lorentz electric field.

Clause 2. The apparatus of clause 1, wherein the electric field sensor is a resonant electric field sensor and the magnetic shield shutter alternatively encloses and does not enclose the resonant electric field sensor at a resonant frequency of the resonant electric field sensor.

Clause 3. The apparatus of clause 1, wherein each Lorentz force velocimeter includes further comprising an electrical actuator configured to cause the magnetic shield shutter to either enclose the electric field sensor or not enclose, at least partially, the electric field sensor.

Clause 4. The apparatus of clause 1, where the at least one Lorentz force velocimeter includes three Lorentz force velocimeters each of which is configured to sense electric field strength in a different orthogonal axis.

Clause 5. The apparatus of clause 1, further comprising navigation processing circuitry configured to: obtain a magnetic field strength at a position of the body; and using the second signal and the magnetic field strength, determine a velocity of the body.

Clause 6. The apparatus of clause 5, wherein the apparatus further comprises a magnetometer communicatively coupled to the navigation processing circuitry and configured to measure the magnetic field strength and/or wherein the navigation processing circuitry comprises a relationship between the magnetic field strength and the position of the body; and wherein the position of the body is obtained from the navigation processing circuitry, inertial circuitry, and/or a global navigation satellite receiver; wherein the navigation processing circuitry is configured to receive the magnetic field strength from the magnetometer and/or to obtain the magnetic field strength, using the position of the body, from the relationship.

Clause 7. The apparatus of clause 6, further comprising the global navigation satellite receiver communicatively coupled to the navigation processing circuitry and/or the inertial circuitry communicatively coupled to the navigation processing circuitry.

Clause 8. The apparatus of clause 5, further comprising: inertial circuitry configured to measure inertial data about the body or to measure the inertial data about the body and using the inertial data to determine of the position of the body and an attitude, with respect to a moving reference frame, of the body; and wherein the navigation processing circuitry is communicatively coupled to the inertial circuitry and configured to: use the inertial data to determining the position of the body and the attitude, with respect to the moving reference frame, of the body or to receive the position of the body and the attitude, with respect to the moving reference frame, of the body; using the velocity of the body, the position of the body and the attitude, with respect to the moving reference frame, of the body, determine another position of the body and another attitude, with respect to the moving reference frame, of the body.

Clause 9. A method for generating a signal representative of Lorentz electrical field strength at a body, the method comprising: for each Lorentz force velocimeter, enclosing an electric field sensor with a magnetic shield shutter; for each Lorentz force velocimeter, not enclosing, at least partially, the electric field sensor with the magnetic shield shutter; for each Lorentz force velocimeter, generating a first signal representing alternatively a strength of a combination of a Lorentz electric field and an ambient electric field and a strength of the ambient electric field; and for each Lorentz force velocimeter, using the first signal, generating a second signal representing a strength of the Lorentz electric field sensed using a Lorent force velocimeter.

Clause 10. The method of clause 9, further comprising: obtaining a magnetic field strength at a position of the body; and using the second signal and the magnetic field strength, determining a velocity of the body.

Clause 11. The method of clause 10, further comprising: either (a) obtaining inertial data about a body, and determining the position of the body and an attitude, with respect to a moving reference frame, of the body, or (b) obtaining the position of the body and the attitude, with respect to the moving reference frame, of the body; and using the velocity of the body, the position of the body, and the attitude, with respect to the moving reference frame, of the body, determining another position and another attitude, with respect to the moving reference frame, of the body.

Clause 12. The method of clause 9, wherein the electric field sensor is a resonant electric field sensor and the magnetic shield shutter alternatively encloses and does not enclose the resonant electric field sensor at a resonant frequency of the resonant electric field sensor.

Clause 13. The method of clause 9, where each Lorentz force velocimeter is of a set of three Lorentz force velocimeters each of which is configured to sense electric field strength in a different orthogonal axis.

Clause 14. An apparatus for generating a signal representative of a Lorentz electrical field strength at a body, the apparatus comprising: the body; and at least one Lorentz force velocimeter, each of which is on and/or in the body and includes: an electric field sensor; a circuit coupled to the electric field sensor; a magnetic shield shutter configured to alternatively enclose the electric field sensor and not enclose, at least partially, the electric field sensor; and wherein the electric field sensor is configured to generate a first signal representing alternatively a strength of a combination of an ambient electric field and a Lorentz electric field and a strength of the ambient electric field; wherein the circuit is configured to, using the first signal, generate a second signal representing a strength of the Lorentz electric field by suppressing the strength of the ambient electric field from the strength of the combination of the ambient electric field and the Lorentz electric field.

Clause 15. The apparatus of clause 14, wherein the electric field sensor is a resonant electric field sensor and the magnetic shield shutter alternatively encloses and does not enclose the resonant electric field sensor at a resonant frequency of the resonant electric field sensor.

Clause 16. The apparatus of clause 14, wherein each Lorentz force velocimeter includes further comprising an electrical actuator configured to cause the magnetic shield shutter to either enclose the electric field sensor or not enclose, at least partially, the electric field sensor.

Clause 17. The apparatus of clause 14, where the at least one Lorentz force velocimeter includes three Lorentz force velocimeters each of which is configured to sense electric field strength in a different orthogonal axis.

Clause 18. The apparatus of clause 14, further comprising navigation processing circuitry configured to: obtain a magnetic field strength at a position of the body; and using the second signal and the magnetic field strength, determine a velocity of the body.

Clause 19. The apparatus of clause 18, wherein the apparatus further comprises a magnetometer communicatively coupled to the navigation processing circuitry and configured to measure the magnetic field strength and/or wherein the navigation processing circuitry comprises a relationship between the magnetic field strength and the position of the body; and wherein the position of the body is obtained from the navigation processing circuitry, inertial circuitry, and/or a global navigation satellite receiver; wherein the navigation processing circuitry is configured to receive the magnetic field strength from the magnetometer and/or to obtain the magnetic field strength, using the position of the body, from the relationship.

Clause 20. The apparatus of clause 18, further comprising: inertial circuitry configured to measure inertial data about the body or to measure the inertial data about the body and using the inertial data to determine of the position of the body and an attitude, with respect to a moving reference frame, of the body; wherein the navigation processing circuitry is communicatively coupled to the inertial circuitry and configured to: use the inertial data to determine the position of the body and the attitude, with respect to the moving reference frame, of the body or to receive the position of the body and the attitude, with respect to the moving reference frame, of the body; and using the velocity of the body, the position of the body and the attitude, with respect to the moving reference frame, of the body, determine another position of the body and another attitude, with respect to the moving reference frame, of the body.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An apparatus for generating a signal representative of a Lorentz electrical field strength at a body, the apparatus comprising:
at least one Lorentz force velocimeter, each of which includes:
an electric field sensor;
a circuit coupled to the electric field sensor;
a magnetic shield shutter configured to alternatively enclose the electric field sensor and not enclose, at least partially, the electric field sensor; and
wherein the electric field sensor is configured to generate a first signal representing alternatively a strength of a combination of an ambient electric field and a Lorentz electric field and a strength of the ambient electric field;
wherein the circuit is configured to, using the first signal, generate a second signal representing a strength of the Lorentz electric field by suppressing the strength of the ambient electric field from the strength of the combination of the ambient electric field and the Lorentz electric field.

2. The apparatus of claim 1, wherein the electric field sensor is a resonant electric field sensor and the magnetic shield shutter alternatively encloses and does not enclose the resonant electric field sensor at a resonant frequency of the resonant electric field sensor.

3. The apparatus of claim 1, wherein each Lorentz force velocimeter includes further comprising an electrical actuator configured to cause the magnetic shield shutter to either enclose the electric field sensor or not enclose, at least partially, the electric field sensor.

4. The apparatus of claim 1, where the at least one Lorentz force velocimeter includes three Lorentz force velocimeters each of which is configured to sense electric field strength in a different orthogonal axis.

5. The apparatus of claim 1, further comprising navigation processing circuitry configured to:
obtain a magnetic field strength at a position of the body; and
using the second signal and the magnetic field strength, determine a velocity of the body.

6. The apparatus of claim 5, wherein the apparatus further comprises a magnetometer communicatively coupled to the navigation processing circuitry and configured to measure the magnetic field strength and/or wherein the navigation processing circuitry comprises a relationship between the magnetic field strength and the position of the body; and
wherein the position of the body is obtained from the navigation processing circuitry, inertial circuitry, and/or a global navigation satellite receiver;
wherein the navigation processing circuitry is configured to receive the magnetic field strength from the magnetometer and/or to obtain the magnetic field strength, using the position of the body, from the relationship.

7. The apparatus of claim 6, further comprising the global navigation satellite receiver communicatively coupled to the navigation processing circuitry and/or the inertial circuitry communicatively coupled to the navigation processing circuitry.

8. The apparatus of claim 5, further comprising:
inertial circuitry configured to measure inertial data about the body or to measure the inertial data about the body and using the inertial data to determine of the position of the body and an attitude, with respect to a moving reference frame, of the body; and
wherein the navigation processing circuitry is communicatively coupled to the inertial circuitry and configured to:
use the inertial data to determining the position of the body and the attitude, with respect to the moving reference frame, of the body or to receive the position of the body and the attitude, with respect to the moving reference frame, of the body;
using the velocity of the body, the position of the body and the attitude, with respect to the moving reference frame, of the body, determine another position of the body and another attitude, with respect to the moving reference frame, of the body.

9. A method for generating a signal representative of Lorentz electrical field strength at a body, the method comprising:
for each Lorentz force velocimeter, enclosing an electric field sensor with a magnetic shield shutter;
for each Lorentz force velocimeter, not enclosing, at least partially, the electric field sensor with the magnetic shield shutter;
for each Lorentz force velocimeter, generating a first signal representing alternatively a strength of a combination of a Lorentz electric field and an ambient electric field and a strength of the ambient electric field; and
for each Lorentz force velocimeter, using the first signal, generating a second signal representing a strength of the Lorentz electric field sensed using a Lorent force velocimeter.

10. The method of claim 9, further comprising:
obtaining a magnetic field strength at a position of the body; and
using the second signal and the magnetic field strength, determining a velocity of the body.

11. The method of claim 10, further comprising:
either (a) obtaining inertial data about a body, and determining the position of the body and an attitude, with respect to a moving reference frame, of the body, or (b) obtaining the position of the body and the attitude, with respect to the moving reference frame, of the body; and
using the velocity of the body, the position of the body, and the attitude, with respect to the moving reference frame, of the body, determining another position and another attitude, with respect to the moving reference frame, of the body.

12. The method of claim 9, wherein the electric field sensor is a resonant electric field sensor and the magnetic shield shutter alternatively encloses and does not enclose the resonant electric field sensor at a resonant frequency of the resonant electric field sensor.

13. The method of claim 9, where each Lorentz force velocimeter is of a set of three Lorentz force velocimeters each of which is configured to sense electric field strength in a different orthogonal axis.

14. An apparatus for generating a signal representative of a Lorentz electrical field strength at a body, the apparatus comprising:
the body; and
at least one Lorentz force velocimeter, each of which is on and/or in the body and includes:
an electric field sensor;
a circuit coupled to the electric field sensor;
a magnetic shield shutter configured to alternatively enclose the electric field sensor and not enclose, at least partially, the electric field sensor; and
wherein the electric field sensor is configured to generate a first signal representing alternatively a strength of a combination of an ambient electric field and a Lorentz electric field and a strength of the ambient electric field;
wherein the circuit is configured to, using the first signal, generate a second signal representing a strength of the Lorentz electric field by suppressing the strength of the ambient electric field from the strength of the combination of the ambient electric field and the Lorentz electric field.

15. The apparatus of claim 14, wherein the electric field sensor is a resonant electric field sensor and the magnetic shield shutter alternatively encloses and does not enclose the resonant electric field sensor at a resonant frequency of the resonant electric field sensor.

16. The apparatus of claim 14, wherein each Lorentz force velocimeter includes further comprising an electrical actuator configured to cause the magnetic shield shutter to either enclose the electric field sensor or not enclose, at least partially, the electric field sensor.

17. The apparatus of claim 14, where the at least one Lorentz force velocimeter includes three Lorentz force velocimeters each of which is configured to sense electric field strength in a different orthogonal axis.

18. The apparatus of claim 14, further comprising navigation processing circuitry configured to:
obtain a magnetic field strength at a position of the body; and
using the second signal and the magnetic field strength, determine a velocity of the body.

19. The apparatus of claim 18, wherein the apparatus further comprises a magnetometer communicatively coupled to the navigation processing circuitry and configured to measure the magnetic field strength and/or wherein the navigation processing circuitry comprises a relationship between the magnetic field strength and the position of the body; and
wherein the position of the body is obtained from the navigation processing circuitry, inertial circuitry, and/or a global navigation satellite receiver;
wherein the navigation processing circuitry is configured to receive the magnetic field strength from the magnetometer and/or to obtain the magnetic field strength, using the position of the body, from the relationship.

20. The apparatus of claim 18, further comprising:
inertial circuitry configured to measure inertial data about the body or to measure the inertial data about the body and using the inertial data to determine of the position of the body and an attitude, with respect to a moving reference frame, of the body;
wherein the navigation processing circuitry is communicatively coupled to the inertial circuitry and configured to:
use the inertial data to determine the position of the body and the attitude, with respect to the moving reference frame, of the body or to receive the position of the body and the attitude, with respect to the moving reference frame, of the body; and
using the velocity of the body, the position of the body and the attitude, with respect to the moving reference frame, of the body, determine another position of the body and another attitude, with respect to the moving reference frame, of the body.
